(19) United States
(12) Patent Application Publication
(10) Pub. No.: US 2004/0239587 A1
(43) Pub. Date: Dec. 2, 2004

(54) Display processor

(76) Inventors: Haruhiko Murata, Osaka (JP); Ryuhei Amano, Osaka (JP)

Correspondence Address: MCDERMOTT, WILL & EMERY, 600 13th Street, N.W., Washington, DC, 20005-3096, US

(21) Appl. No.: 10/809,800

(22) Filed: Mar. 26, 2004

(30) Foreign Application Priority Data
Mar. 28, 2003 (JP) JP2003-092942

(51) Int. Cl. G09G 3/20

(52) U.S. Cl. 345/58

(57) ABSTRACT

A display processor for suppressing the occurrence of crosstalk. The display processor according to the present invention includes: an average obtaining unit which obtains the average of pixel values in a predetermined area on a line; a difference value operation unit which calculates a pixel difference value between the average pixel value and the pixel value of a target pixel to be corrected; and a processing unit which corrects the target pixel value according to the pixel difference value. Since the occurrence of crosstalk is suppressed by means of signal processing, it is unnecessary to use any complicated expensive structure. This makes it possible to achieve a display processor easy to control. The processing unit may also obtain a variation in pixel value near the target pixel to be corrected, and correct the target pixel value according to this variation.

### BACKGROUND OF THE INVENTION

1. Field of the Invention

The present invention relates to a display processing technology for displaying an image, and more particularly to a display processing technology for suppressing the occurrence of crosstalk.

2. Description of the Related Art

Presently, the displays of portable communication terminals and personal computers are composed principally of liquid crystal panels. For displays of the next generation as alternatives to the liquid crystal panels, organic electroluminescence panels and inorganic electroluminescence panels have been a focus of recent attention. Such displays are provided with pixels arranged in a matrix, and are driven chiefly by two types of driving systems, or an active matrix driving system and a passive matrix driving system.

Among important issues concerning the displays is the occurrence of horizontal or vertical crosstalk. A crosstalk phenomenon refers to one in which a fixed pattern such as a window is displayed with brightness variations in areas horizontally adjoining the pattern. The brightness variations are considered to result from voltage drops on electrode lines, the voltage drops occurring from high currents flowing through the lines.

FIG. 1 shows an example of a display image in which a crosstalk phenomenon occurs. Suppose the case of displaying a white window on a uniform halftone background. On a line A-A′ SA-70123 which includes pixels of the window, the input signal level makes such changes in the horizontal direction as 0.3 in the range from pixel 1 to pixel (p−1), 1.0 in the range from pixel p to pixel (q−1), and 0.3 in the range from pixel q to pixel r. On a line B-B′ which includes no window pixel, the input signal level is maintained at 0.3 across all the pixels. Here, as shown in the diagram, brightness variations are observed in the areas on the right and left of the window on the horizontal line as compared to the windowless line. Such brightness variations are unfavorable in terms of quality. Then, there have heretofore been proposed active matrix type liquid crystal displays comprising crosstalk suppressing information detecting means which indirectly detect potential variations of a common electrode resulting from changes in a driving voltage of signal wiring, and a filter circuit which corrects the detected potential variations (for example, see Japanese Patent Laid-Open Publication No. 2002-123227).

### SUMMARY OF THE INVENTION

Nevertheless, crosstalk suppression is desirably achieved by as simple a configuration as possible.

It is thus an object of the present invention to provide a display processor which performs signal processing capable of suppressing the occurrence of crosstalk with a simple configuration.

To solve the foregoing problem, one of the aspects of the present invention provides a display processor. The display processor comprises: a first obtaining unit which obtains an average pixel value, or an average of pixel values in a predetermined area on a line; an operation unit which calculates a pixel difference value, or a difference between the average pixel value and a pixel value of a target pixel to be corrected; a processing unit which corrects the target pixel value, or the pixel value of the target pixel, according to the pixel difference value; and a display unit which displays the pixel value corrected. Since the display processor of this aspect corrects pixel values by using average pixel values, it becomes possible to suppress crosstalk-based brightness variations effectively by means of signal processing.

The processing unit may comprise a second obtaining unit which obtains a variation in pixel value near the target pixel, and a correction unit which corrects the target pixel value according to the variation. The processing unit preferably decreases the amount of correction of the target pixel value with an increasing variation, and increases the amount of correction of the target pixel value with a decreasing variation.

The second obtaining unit may obtain the variation based on adjoining-pixel difference absolute values, or absolute values of differences between the pixel values of pixels adjoining within a certain area near the target pixel. The second obtaining unit may obtain the variation based on an integrated value of the adjoining-pixel difference absolute values. If an adjoining-pixel difference absolute value exceeds a threshold, the second obtaining unit may determine an integrated value by subjecting the threshold to the integration instead of the adjoining-pixel difference absolute value. The second obtaining unit may compare each of the adjoining-pixel difference absolute values between adjoining pixels within a certain area near the target pixel with a threshold, and obtain the variation based on the counted number of adjoining-pixel difference absolute values exceeding the threshold.

The processing unit may correct the target pixel value according to the position of the target pixel on the display unit. The first obtaining unit may obtain the averages or integrated values of the pixel values in predetermined areas on a plurality of lines including the abovementioned predetermined area on the line. Here, the operation unit calculates a line difference value, or a difference between the average pixel values or integrated values of the lines, and the processing unit corrects the target pixel value according to the line difference value. When the display unit is split into a plurality of areas for driving, the processing unit may correct the pixel value of a pixel at a position symmetrical to the target pixel in the split area.

Incidentally, any combinations of the foregoing components, and the expressions of the present invention converted among methods, apparatuses, systems, and the like are also intended to constitute applicable aspects of the present invention.

This summary of the invention does not necessarily describe all necessary features so that the invention may also be a sub-combination of these described features.

### BRIEF DESCRIPTION OF THE DRAWINGS

FIG. 1 is a diagram showing an example of a display image in which a crosstalk phenomenon occurs;

FIG. 2 is a diagram showing the module configuration of a matrix-driven type display unit;

FIG. 3 is a diagram showing the configuration of a display processor;

FIG. 4 is a diagram showing the configuration of a processing unit;

FIG. 5 is a chart showing an example of a correction level control characteristic;

FIG. 6 is a diagram showing an image to appear on the display unit and examples of the pixel values, or signal levels, on horizontal lines;

FIG. 7 is a chart showing an example of a correction gain control characteristic for adjusting the correction level;

FIG. 8 is a chart for explaining an example of the method for calculating a variation;

FIG. 9(a) is a diagram showing an example of display on the display unit and input signal levels when uneven crosstalk occurs, and FIG. 9(b) is a diagram showing signal levels for correcting target pixel values according to the positions of the target pixels to be corrected on the display unit;

FIG. 10(a) is a diagram showing an example of display on the display unit and input signal levels when crosstalk occurs at the boundaries between a crosstalk-occurring area and crosstalk-free areas, and FIG. 10(b) is a diagram showing signal levels for correcting the target pixel values by suppressing the crosstalk at the boundaries;

FIG. 11 is a chart showing another example of the correction gain control characteristic for adjusting the correction level; and

FIG. 12(a) is a diagram showing an example of display when crosstalk occurs between symmetrical areas on the display unit, and FIG. 12(b) is a diagram showing signal levels for correcting target pixel values by suppressing the crosstalk between the symmetrical areas.

### DETAILED DESCRIPTION OF THE INVENTION

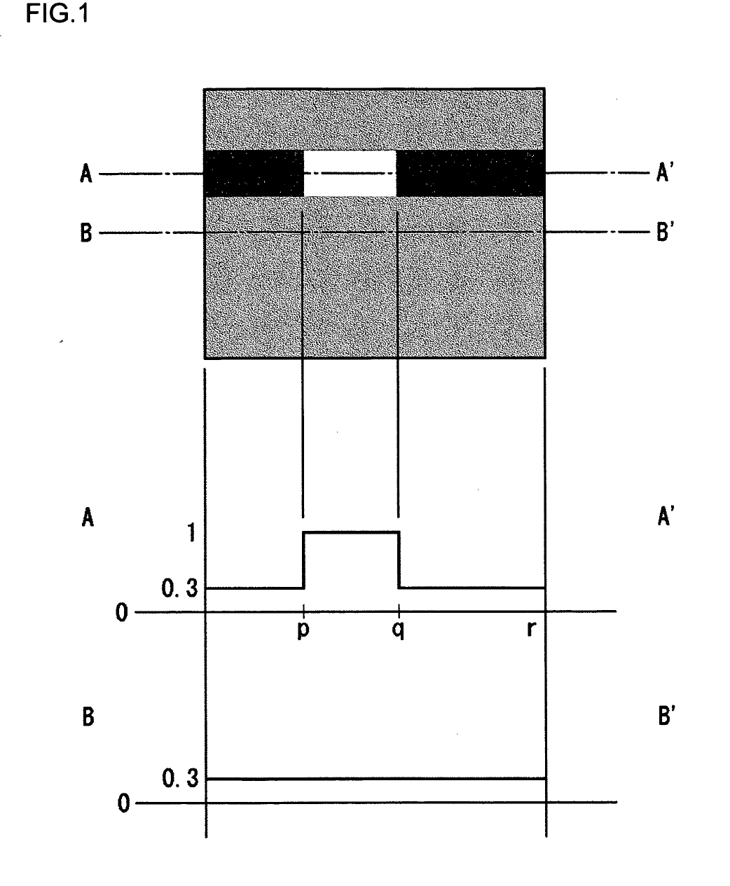

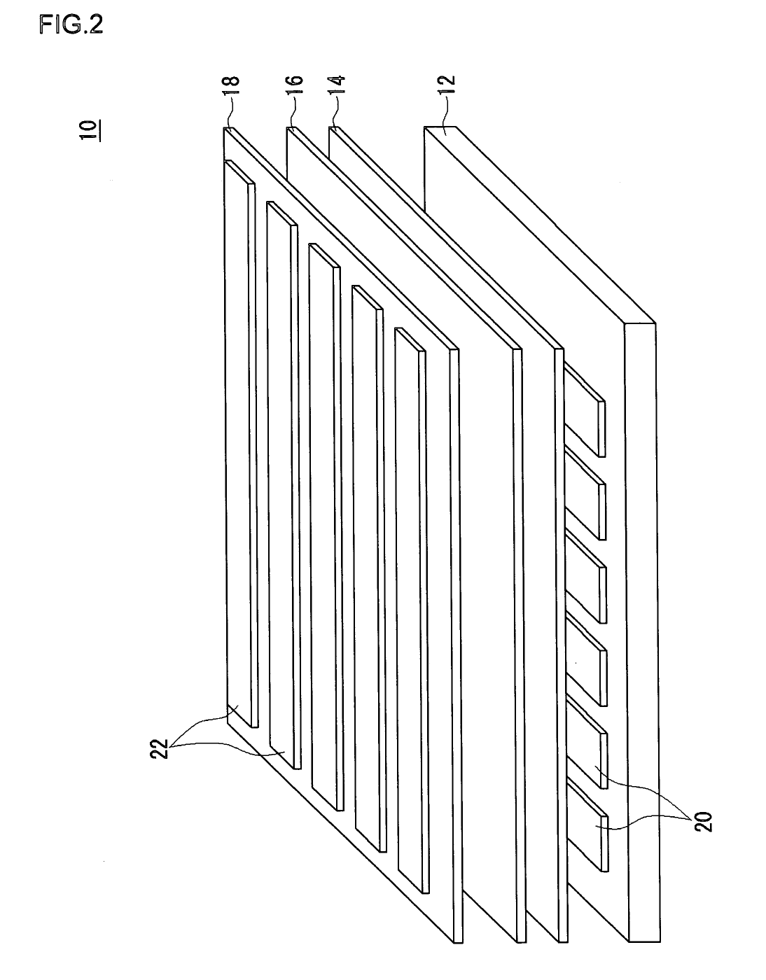

FIG. 2 shows the module configuration of a matrix-driven type display unit 10. The display unit 10 has the structure that a luminescent layer 16 is sandwiched between two insulating layers 14 and 18 on a substrate 12 which is made of glass, ceramic, or the like. A plurality of data electrodes 20 are arranged in parallel on the substrate 12. A plurality of scanning electrodes 22 are arranged in parallel on the insulating layer 18, at right angles to the data electrodes 20. When the display unit 10 displays a white window, the scanning electrodes 22 in the window-displaying area can cause voltage drops with a crosstalk phenomenon as shown in FIG. 1 if the signal levels set as the respective pixel values are applied to the scanning electrodes as is.

Then, in the present embodiment, the pixel values, i.e., the signal levels shall be corrected through signal processing to suppress the occurrence of crosstalk. While FIG. 2 shows the configuration of the display unit 10 of an organic EL panel, inorganic EL panel, or the like which has the luminescent layer 14, the display unit 10 may be formed as a matrix-driven type liquid crystal panel.

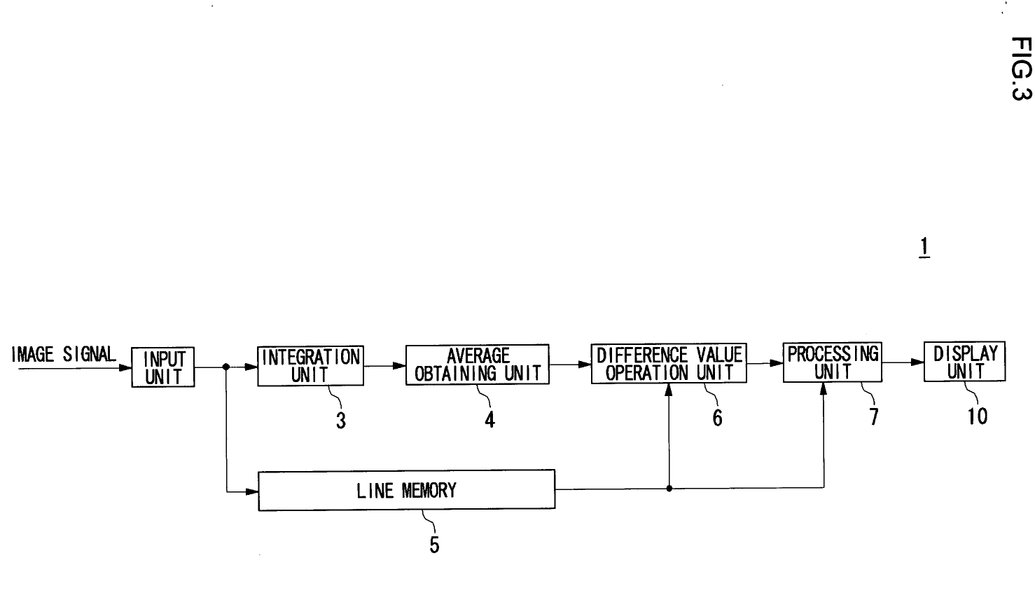

FIG. 3 shows the configuration of a display processor 1 according to the embodiment. The display processor 1 comprises an input unit 2, an integration unit 3, an average obtaining unit 4, a line memory 5, a difference value operation unit 6, a processing unit 7, and the display unit 10. The display unit 10 is provided with a display panel and a driving circuit for matrix driving.

The input unit 2 initially accepts an image signal and supplies it to the line memory 5. The line memory 5 stores the image signal for a single line of the display unit 10, i.e., the pixel values of a lineful of pixels. The integration unit 3 integrates the lineful of pixel values stored in the line memory 5. In this example, the integration unit 3 integrates the pixel values simultaneously with the input of the image signal to the line memory 5. Nevertheless, the pixel values may be integrated at any timing, such as when they are output from the line memory 5. When a lineful of image signal is input to the line memory 5, the integration unit 3 transmits the integrated value of the lineful of pixel values to the average obtaining unit 4. The average obtaining unit 4 divides the integrated value of the pixel values by the number of pixels, thereby calculating and obtaining the average of the pixel values on that line. Incidentally, in such cases that the image signal is read from its source with previously-calculated averages, the average obtaining unit 4 may accept those averages. In the case of FIG. 1, the average pixel value on the line A-A′ is expressed as (0.3×r+0.7×(q−p))/r. The average pixel value on the line B-B′ is 0.3.

The difference value operation unit 6 receives the average pixel value for a single line from the average obtaining unit 4. The difference value operation unit 6 calculates pixel difference values between this average pixel value and the pixel values of the target pixels to be corrected, i.e., the signal levels output from the line memory 5. The target pixels to be corrected may be all the lineful of pixels. The pixel difference values calculated are sent to the processing unit 7.

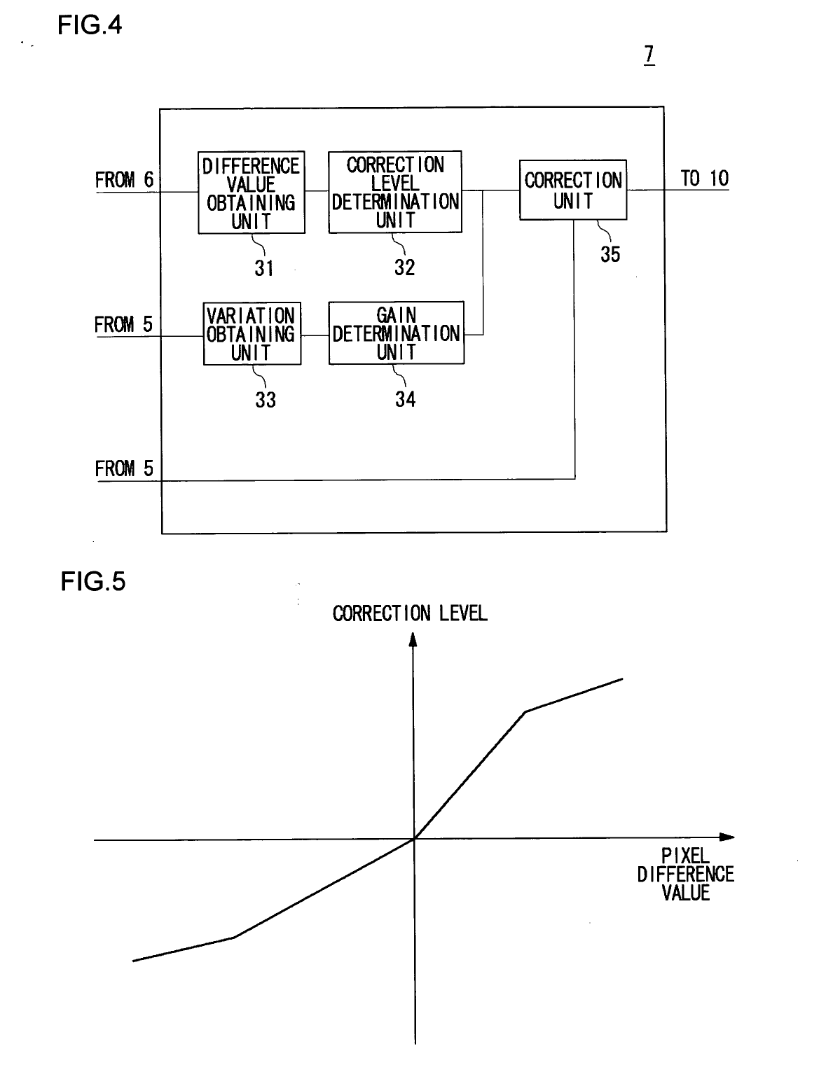

FIG. 4 shows the configuration of the processing unit 7. The processing unit 7 has a difference value obtaining unit 31, a correction level determination unit 32, a variation obtaining unit 33, a gain determination unit 34, and a correction unit 35. The difference value obtaining unit 31 obtains pixel difference values from the difference value operation unit 6, and transmits the same to the correction level determination unit 32. Based on the pixel difference values, the correction level determination unit 32 determines the correction level of the pixel values to be corrected. The correction level is a factor to be added/subtracted to/from the original pixel values by the correction unit 35.

FIG. 5 shows an example of a correction level control characteristic. The abscissa represents the pixel difference value, and the ordinate the correction level. According to this correction level control characteristic, a correction level can be set uniquely for each pixel difference value. The inventor has confirmed that the greater a pixel difference value, i.e., the difference between the average pixel value and a target pixel value to be corrected is, the greater the brightness variation occurring from the crosstalk phenomenon is. Based on the finding, the inventor has contrived the correction level control characteristic that increases the correction level with an increase in the absolute value of the pixel difference value. While the correction level control characteristic shown in FIG. 5 is asymmetrical about the origin point, it may be symmetrical and is preferably set according to such factors as the structure of the display unit 10. Returning to FIG. 4, the correction level determination unit 32 determines the correction level of the target pixel values by using this correction level control characteristic. The correction unit 35 adds/subtracts the determined correction level to/from the target pixel values to correct the target pixel values. The pixel values corrected are sent to the driving circuit of the display unit 10, and processed as the signals for the corresponding pixels.

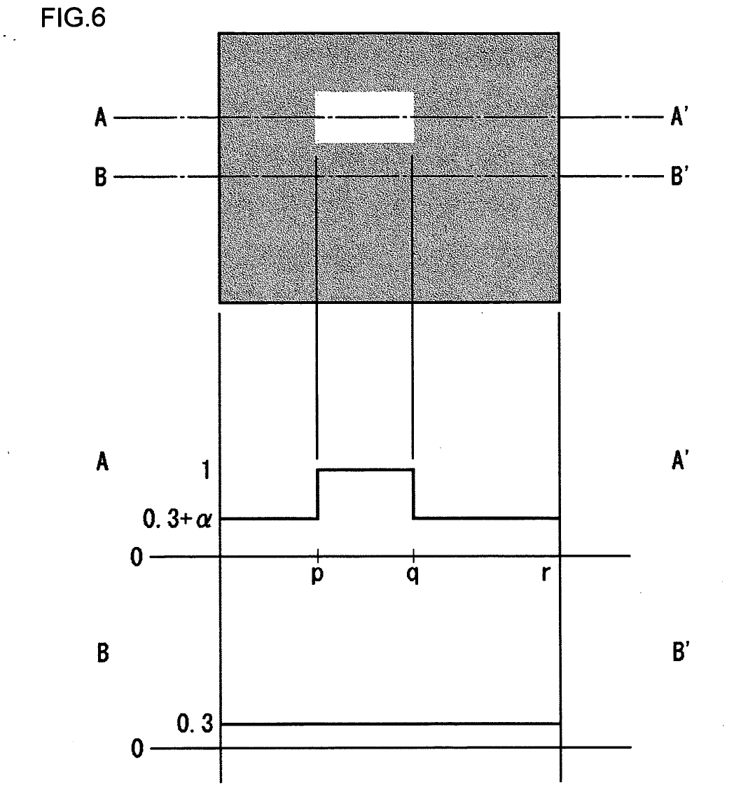

FIG. 6 shows an image to appear on the display unit 10 and examples of the corrected pixel values, or signal levels, on the horizontal lines. On the line A-A′, a correction level of α is determined from the pixel difference values. In the range from pixel 1 to pixel (p−1) and in the range from pixel q to pixel r, the signal levels can be set at (0.3+a) to suppress the occurrence of crosstalk. In this example, no correction is made to the signal levels in the range from pixel p to pixel (q−1). The correction processing may thus be applied to only the areas that are greatly affected by voltage drops. In another example, the correction processing may be applied to even the range from pixel p to pixel (q−1). On the line B-B′, all the pixel values are the average value of 0.3, with pixel difference values of 0. No correction processing is thus applied to the original pixel values.

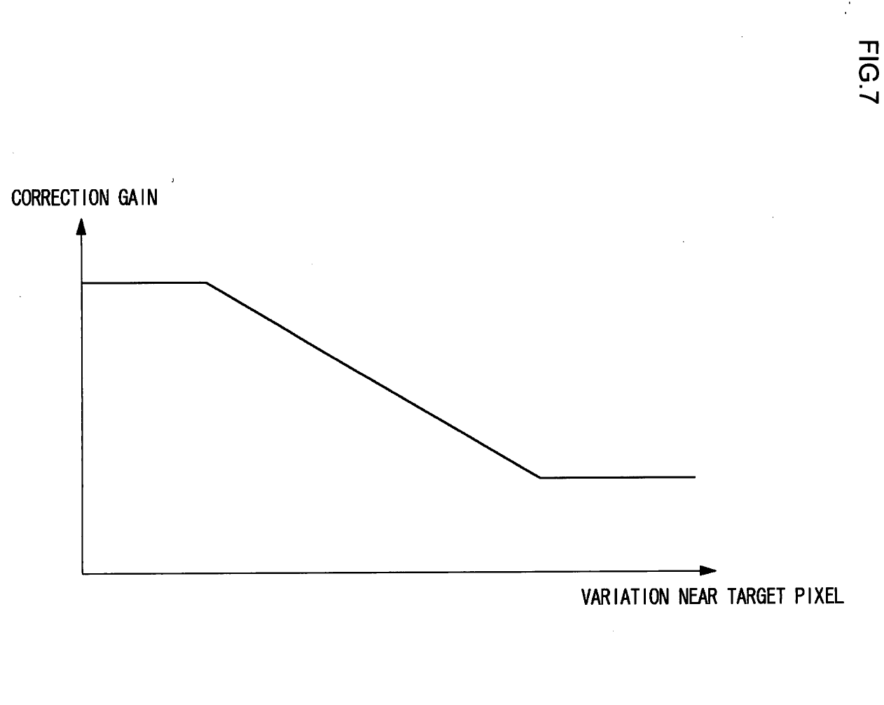

FIG. 7 shows an example of a correction gain control characteristic for adjusting the correction level. The abscissa represents a variation in pixel value near a target pixel to be corrected. The ordinate represents the correction gain. In the present embodiment, the correction gain and the determined correction level are multiplied and used as the factor for adjusting the amount of correction of target pixels. According to this correction gain control characteristic, a correction gain can be set uniquely for each variation in the pixel value near a target pixel to be corrected. Incidentally, the correction gain control characteristic is preferably set according to such factors as the configuration of the display unit 10.

Crosstalk tends to occur when generally uniform images are displayed on the display unit 10, and less likely when minute patterns are displayed. In view of this, variations in the pixel values of adjacent pixels of a target pixel to be corrected, lying on the same line, are determined to evaluate crosstalk-based brightness variations. The correction level determined by the correction level determination unit 32 is then adjusted.

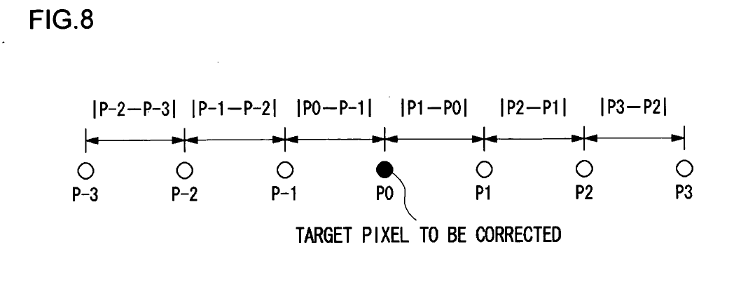

FIG. 8 is a diagram for explaining an example of the method for calculating variations. The variation obtaining unit 33 receives a lineful of pixel values from the line memory 5, and determines variations. Initially, three adjacent pixels of a target pixel to be corrected, lying on the same horizontal line, are assumed in either direction. The numbers of pixels are not limited to three, but are preferably set symmetrically wherever possible. As shown in the diagram, the pixels shall have pixel values of (P−3), (P−2), (P−1), P0, P1, P2, and P3, staring from the left.

The variation obtaining unit 33 determines differences between the pixel values of adjoining pixels out of the assumed pixels, and determines the absolute values thereof. In this case, the variation obtaining unit 33 calculates |(P−3)−(P−2)|, |(P−2)−(P−1)|, |(P−1)−P0)|, |P1−P0|, |P2−P1|, and |P3−P2| as pixel difference absolute values between the adjoining pixels. Then, the variation obtaining unit 33 determines an integrated value thereof as a variation. In the case of uniform display containing fewer brightness variations as a whole, pixel difference values between adjoining pixels become smaller. Then, the integrated value of the absolute values thereof, or variation, also becomes smaller. Consequently, when variations are small, the display can be evaluated as being uniform, which means that the display tends to cause crosstalk. By contrast, when the integrated values of the pixel difference absolute values are great, the display can be evaluated as including minute patterns or the like. This means that the display is less likely to cause crosstalk.

As described above, the variation obtaining unit 33 obtains the integrated value of the pixel difference absolute values between the adjoining pixels near a target pixel to be corrected as the variation. Then, the gain determination unit 34 can determine the correction gain based on the correction gain control characteristic shown in FIG. 7. This correction gain control characteristic is such that the correction gain decreases with an increasing variation and increases with a decreasing variation. As mentioned previously, the reason for this is that great variations arise when crosstalk is less likely to occur, and the amount of correction of the pixel values thus need not be high. When variations are small, on the other hand, the amount of correction of the pixel values must be high since the display tends to cause crosstalk. Consequently, when variations are great, the gain determination unit 34 determines a correction gain which decreases the amount of correction of the target pixel values. When variations are small, the gain determination unit 34 determines a correction gain which increases the amount of correction. The correction unit 35 multiplies the correction level by the correction gain, and corrects the target pixel values by adding/subtracting the multiplied value to/from the target pixel values.

In the example described above, the pixel difference absolute values between pixels are integrated at the time of obtaining variations. Nevertheless, in preparation for the case where pixel values vary sharply, variations may be obtained effectively by using a threshold. Referring to the example of display in FIG. 1, the pixel values at the edges on the line A-A′, such as at pixels p and q, vary sharply from those of the adjoining pixels. On this account, if pixels p and q themselves or adjacent pixels are to be corrected, the pixel difference absolute values between adjoining pixels increase significantly at the edges. When the integrated values thereof are regarded as variations, the great differences in pixel value at the edges can thus result in the evaluation that the display is high in pixel value variation even if the display is uniform except at the edges. Then, the variation obtaining unit 33 shall compare pixel difference absolute values with a predetermined threshold, and if the threshold is exceeded, determine the integrated value of the pixel difference absolute values by integrating the threshold instead of the pixel difference absolute values. As a result, excessively-large pixel difference absolute values can be replaced with a predetermined value when edges arise at some points, i.e., when the pixel values vary sharply. This enhances the reliability of the variations which are obtained for the sake of grasping the display characteristic.

In another example, variations can be obtained by using only the results of comparison between the calculated pixel difference absolute values and a threshold. In this case, the pixel difference absolute values and the threshold are compared, and the number of pixel difference absolute values that exceed the threshold is counted. This can absorb the impact of sharp changes in pixel value upon the variation calculation, making it possible to obtain variations with higher reliability.

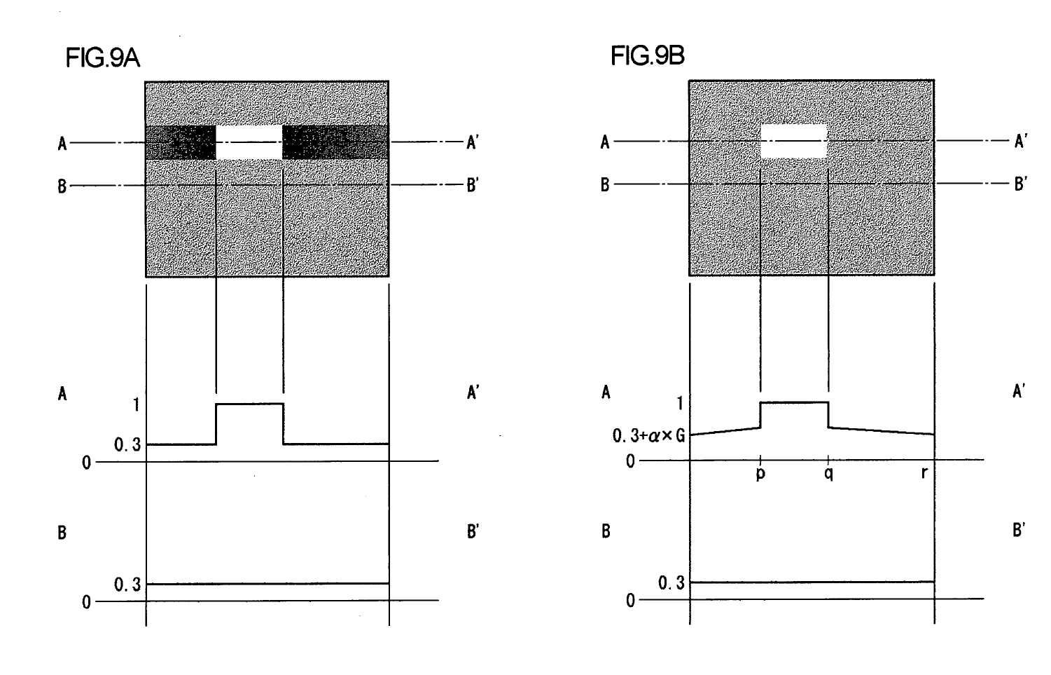

FIG. 9(a) shows an example of display on the display unit 10 and the input signal levels when uneven crosstalk occurs. This phenomenon results from pixel-by-pixel differences in voltage drop due to the fact that the display unit 10 varies in resistance from one pixel position to another. This FIG. 9(a) shows how the level of brightness variation changes depending on the pixel positions of the display unit 10 on the line A-A′. In such a case, the gain determination unit 34 determines the correction gain in accordance with pixel positions on the display unit 10.

For example, the gain determination unit 34 may determine the correction gain based on the distance from an end of the line. If the power is supplied from line ends, the voltage drop increases inward. It is thus preferable that the gain determination unit 34 determine the correction gain taking account of those variations in voltage drop.

FIG. 9(b) shows the signal level which corrects the target pixel values in accordance with the positions of the target pixels to be corrected on the display unit 10. On the line A-A′, the crosstalk-occurring areas are given position-based amounts of correction. More specifically, in the range from pixel 1 to pixel (p−1) and in the range from pixel q to pixel r, the amounts of correction have gradients. This makes it possible to suppress crosstalk-based brightness variations depending on pixel positions, thereby achieving preferable screen display.

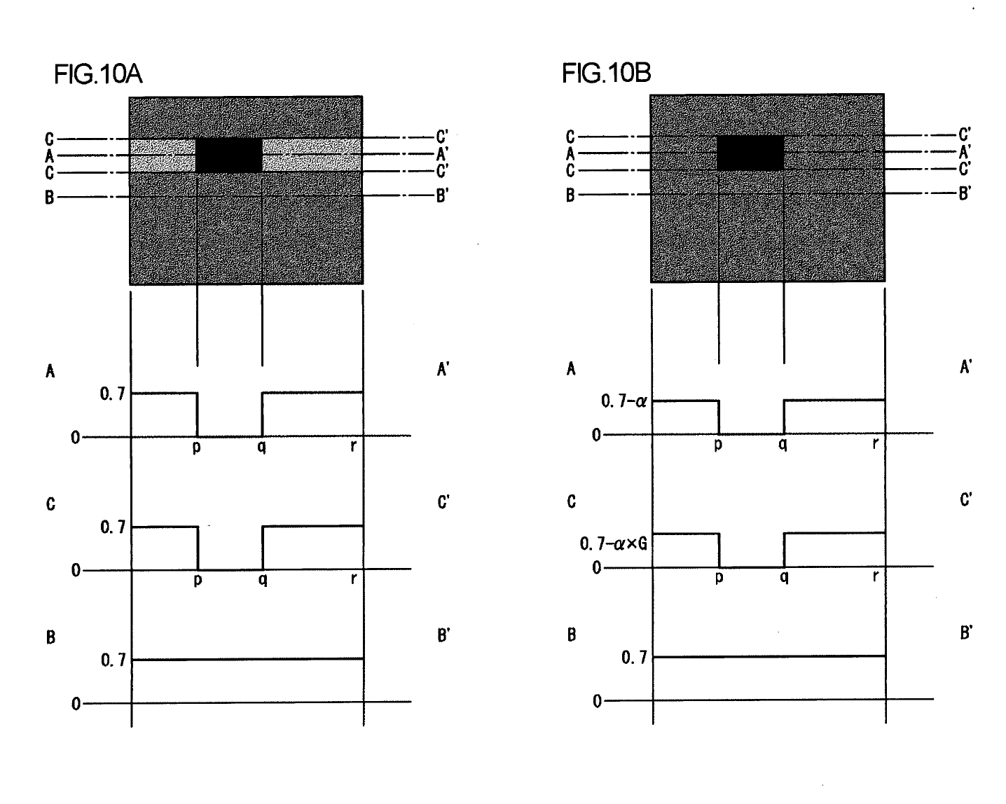

FIG. 10(a) shows an example of display on the display unit 10 and the input signal levels when crosstalk occurs at the boundaries between crosstalk-occurring areas and crosstalk-free areas. In this example, a black window is displayed. The occurrence of crosstalk on horizontal lines also causes crosstalk in the vertical directions. More specifically, in this phenomenon, horizontal-line crosstalk occurs on the line A-A′, and vertical crosstalk also occurs at the two boundaries designated by the lines C-C′.

FIG. 10(b) shows the signal levels for suppressing the crosstalk at the boundaries to correct the target pixel values. Initially, the boundaries are detected by utilizing the average pixel values of horizontal lines. The average pixel value of the line A-A′ is expressed as 0.7×(p+r−q)/r. The average pixel value of the line B-B′ is 0.7. As with the line A-A′, the average pixel values of the lines C-C′ at the boundaries are also expressed as 0.7×(p+r−q)/r. Incidentally, the integrated values of the pixel values on the horizontal lines may be used instead of the average pixel values.

Returning to FIGS. 3 and 4, the average obtaining unit 4 obtains the average pixel values of a plurality of horizontal lines, and supplies the same to the difference value operation unit 6. The difference value operation unit 6 determines differences between the average pixel values of lines adjoining vertically, thereby calculating line difference values. The difference value obtaining unit 31 of the processing unit 7 receives the line difference values calculated.

In the example of display shown in FIG. 10(a), the horizontal lines in the crosstalk-occurring area and in the crosstalk-free areas have the same respective average pixel values. Thus, the line difference values calculated within these areas are zero. Meanwhile, the boundaries between the occurring area and the free areas, i.e., the horizontal lines C-C′ have a line difference value which is given by 0.7−(0.7×(p+r−q)/r)=0.7×(q−p)/r. If the line difference values exceed a predetermined threshold, the difference value obtaining unit 31 determines that the lines are boundaries.

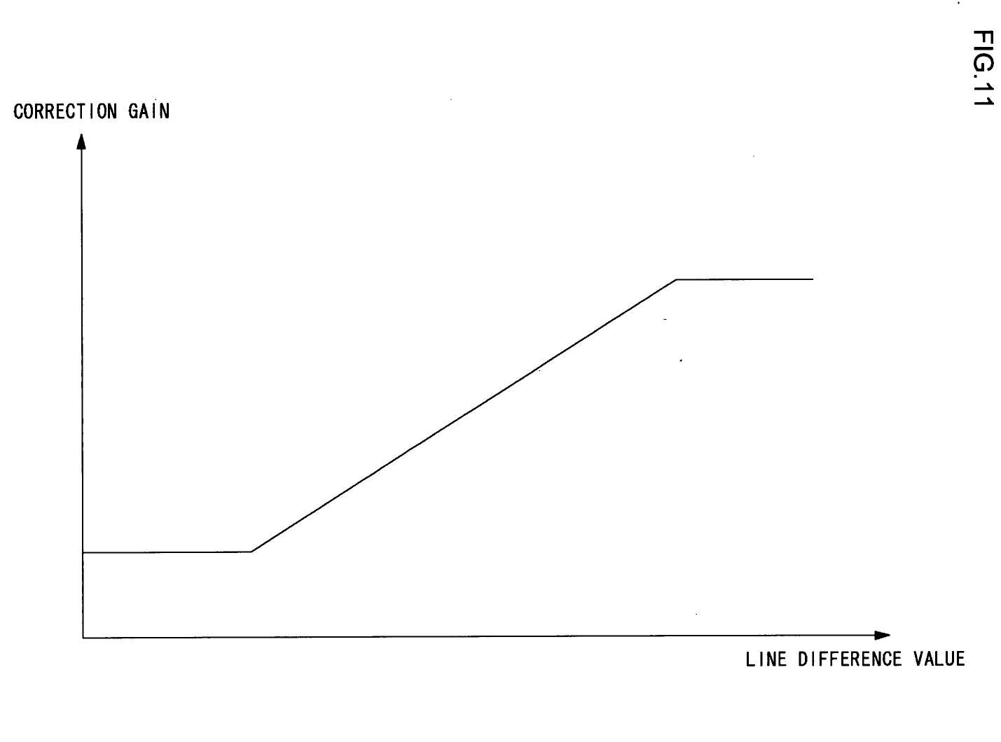

FIG. 11 shows another example of the correction gain control characteristic for adjusting the correction level. The abscissa represents the line difference value, and the ordinate the correction gain. In the present embodiment, the correction gain and the determined correction level are multiplied and used as the factor for adjusting the amount of correction of target pixels. According to this correction gain control characteristic, a correction gain can be set uniquely for each line difference value. Take, for example, the case where the line A-A′ has a correction level of α as described so far. If the correction gain of the lines C-C′ is set to G by using the correction gain control characteristic shown in FIG. 11, the pixel values on the lines C-C′ are corrected to (0.7−α×G). Crosstalk occurring in the directions orthogonal to the lines increases brightness variations depending on the line difference values. Thus, the correction gain control characteristic is set so as to increase the correction gain with an increasing line difference value, and decrease the correction gain with a decreasing line difference value.

Consequently, on the lines C-C′ of FIG. 10(b), the signal levels are set to (0.7−α×G). Since the target pixel values are corrected according to the line difference values between the horizontal lines, it becomes possible to suppress the crosstalk that occurs in the vertical directions.

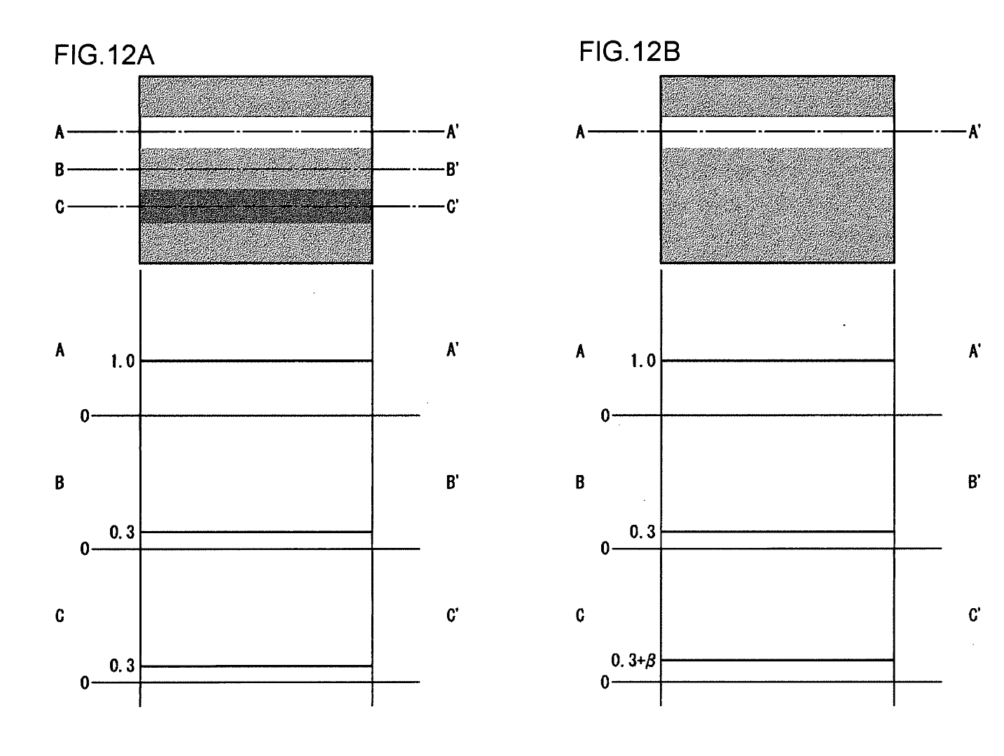

FIG. 12(a) shows an example of display where crosstalk occurs between symmetrical areas on the display unit 10. The display unit 10 is sometimes split into a plurality of areas for driving, by such a method as vertical split driving. Given this case, i.e., when the display unit 10 is vertically split for driving, the supply of power in one of the areas can affect the brightness of the pixels at symmetrical positions in the other area because of symmetrical driving. As shown in FIG. 12(a), crosstalk can thus occur on a line C-C′ which lies in the position symmetrical to the line A-A′.

FIG. 12(b) shows the signal levels for suppressing the crosstalk at the symmetrical position, thereby correcting the target pixel values. In this case, for example, the line A-A′ and the line C-C′ may be considered as a single horizontal line and corrected by the method described above. Even if the line A-A′ includes a window area, pixel values can be corrected accordingly as described previously. It is therefore possible to suppress the crosstalk which has occurred on the line C-C′ in the position symmetrical to the line A-A′, thereby promising preferable image quality.

Up to this point, the present invention has been described in conjunction with the embodiment. This embodiment is given solely by way of illustration. It will be understood by those skilled in the art that various modifications may be made to combinations of the foregoing components and processes, and all such modifications are also intended to fall within the scope of the present invention. While the embodiment has chiefly dealt with the case of displaying a white window, the pixel values can be corrected similarly even in displaying a black window. Moreover, in the embodiment, the pixel values are averaged for each single line. This is not restrictive, however. A target pixel value may be corrected by using an average of pixel values in a predetermined area on the line.

What is claimed is:

1. A display processor comprising:
a first obtaining unit which obtains an average pixel value, or an average of pixel values in a predetermined area on a line;
an operation unit which calculates a pixel difference value, or a difference between the average pixel value and a pixel value of a target pixel to be corrected;
a processing unit which corrects the target pixel value, or the pixel value of the target pixel, according to the pixel difference value; and
a display unit which displays the pixel value corrected.

2. The display processor according to claim 1, wherein
the processing unit comprises:
a second obtaining unit which obtains a variation in pixel value near the target pixel; and
a correction unit which corrects the target pixel value according to the variation.

3. The display processor according to claim 2, wherein
the processing unit decreases the amount of correction of the target pixel value with an increasing variation, and increases the amount of correction of the target pixel value with a decreasing variation.

4. The display processor according to claim 2, wherein
the second obtaining unit obtains the variation based on adjoining-pixel difference absolute values, or absolute values of differences between the pixel values of pixels adjoining within a certain area near the target pixel.

5. The display processor according to claim 3, wherein
the second obtaining unit obtains the variation based on adjoining-pixel difference absolute values, or absolute values of differences between the pixel values of pixels adjoining within a certain area near the target pixel.

6. The display processor according to claim 4, wherein
the second obtaining unit obtains the variation based on an integrated value of the adjoining-pixel difference absolute values.

7. The display processor according to claim 5, wherein
the second obtaining unit obtains the variation based on an integrated value of the adjoining-pixel difference absolute values.

8. The display processor according to claim 4, wherein
if an adjoining-pixel difference absolute value exceeds a threshold, the second obtaining unit determines an integrated value by subjecting the threshold to the integration instead of the adjoining-pixel difference absolute value.

9. The display processor according to claim 5, wherein
if an adjoining-pixel difference absolute value exceeds a threshold, the second obtaining unit determines an integrated value by subjecting the threshold to the integration instead of the adjoining-pixel difference absolute value.

10. The display processor according to claim 2, wherein
the second obtaining unit compares each of the adjoining-pixel difference absolute values between adjoining pixels within a certain area near the target pixel with a threshold, and obtains the variation based on the counted number of adjoining-pixel difference absolute values exceeding the threshold.

11. The display processor according to claim 3, wherein
the second obtaining unit compares each of the adjoining-pixel difference absolute values between adjoining pixels within a certain area near the target pixel with a threshold, and obtains the variation based on the counted number of adjoining-pixel difference absolute values exceeding the threshold.

12. The display processor according to claim 4, wherein
the second obtaining unit compares each of the adjoining-pixel difference absolute values between adjoining pixels within a certain area near the target pixel with a threshold, and obtains the variation based on the counted number of adjoining-pixel difference absolute values exceeding the threshold.

13. The display processor according to claim 5, wherein
the second obtaining unit compares each of the adjoining-pixel difference absolute values between adjoining pixels within a certain area near the target pixel with a threshold, and obtains the variation based on the counted number of adjoining-pixel difference absolute values exceeding the threshold.

14. The display processor according to claim 1, wherein
the processing unit corrects the target pixel value according to the position of the target pixel on the display unit.

15. The display processor according to claim 1, wherein
the first obtaining unit obtains the averages or integrated values of the pixel values in predetermined areas on a plurality of lines including the predetermined area on the line,
the operation unit calculates a line difference value, or a difference between the average pixel values or integrated values of the lines, and
the processing unit corrects the target pixel value according to the line difference value.

16. The display processor according to claim 1, wherein
when the display unit is split into a plurality of areas for driving, the processing unit corrects the pixel value of a pixel at a position symmetrical to the target pixel in the split area.

17. An inorganic EL display processor comprising:
a first obtaining unit which obtains an average pixel value, or an average of pixel values in a predetermined area on a line;
an operation unit which calculates a pixel difference value, or a difference between the average pixel value and a pixel value of a target pixel to be corrected;
a processing unit which corrects the target pixel value, or the pixel value of the target pixel, according to the pixel difference value; and
a display unit which displays the pixel value corrected.

18. The inorganic EL display processor according to claim 17, wherein
the processing unit comprises:
a second obtaining unit which obtains a variation in pixel value near the target pixel; and
a correction unit which corrects the target pixel value according to the variation.

19. An organic EL A display processor comprising:
a first obtaining unit which obtains an average pixel value, or an average of pixel values in a predetermined area on a line;
an operation unit which calculates a pixel difference value, or a difference between the average pixel value and a pixel value of a target pixel to be corrected;
a processing unit which corrects the target pixel value, or the pixel value of the target pixel, according to the pixel difference value; and
a display unit which displays the pixel value corrected.

20. The organic EL display processor according to claim 19, wherein
the processing unit comprises:
a second obtaining unit which obtains a variation in pixel value near the target pixel; and
a correction unit which corrects the target pixel value according to the variation.
